(19) United States
(12) Patent Application Publication
(10) Pub. No.: US 2005/0182646 A1
(43) Pub. Date: Aug. 18, 2005

(54) Method and system for reporting economic impact

(76) Inventor: Robert E. Gilmore, Davie, FL (US)

Correspondence Address: John Wiley Horton;Pennington, Moore, Wilkinson, Bell & Dunbar, P.A., 2nd Floor, 215 S. Monroe St., Tallahassee, FL, 32301, US

(21) Appl. No.: 11/038,916

(22) Filed: Jan. 20, 2005

Related U.S. Application Data
(60) Provisional application No. 60/537,698, filed on Jan. 20, 2004.

(51) Int. Cl. G06F 17/60

(52) U.S. Cl. 705/1

(57) ABSTRACT

A new method for determining and reporting the economic impact of a purchasing decision on a community. The method involves collecting economic data for a state or county such as gross economic output, value added, labor income, indirect business taxes, and employment. Once the data is collected, the data is assigned to fields and permissions are assigned. The user can use the system to generate impact reports for the state or county by selecting the state or county of interest, and the appropriate industry category and project dollar amount. Such impact results can show the impact of purchasing decision on the community in terms of employment, indirect business taxes, value added, labor income, and capital income.

### CROSS-REFERENCES TO RELATED APPLICATIONS

This is a non-provisional patent application claiming the benefit under 37 C.F.R. section 1.53 of an earlier-filed provisional application. The earlier filed application was assigned Ser. No. 60/537,698 and listed the same inventor.

### STATEMENT REGARDING FEDERALLY SPONSORED RESEARCH OR DEVELOPMENT

Not Applicable.

### MICROFICHE APPENDIX

Not Applicable

### BACKGROUND OF THE INVENTION

1. Field of the Invention

This invention relates to the field of economic assessment tools. More specifically, the invention comprises a method and system for determining and reporting the economic impact of a purchasing decision on a community.

2. Description of the Related Art

Cities, counties, and public agencies commonly use competitive contracting in an effort to maximize resources, increase work efficiency, and lower taxpayer costs. One common approach is to utilize cooperative purchasing or “bundling.” By utilizing cooperative purchasing, a city is able to obtain discounts on commercial items which would ordinarily be unavailable to them because of the small volumes at which they buy.

There is a belief among most purchasing agencies that bundled contracts are eventually subcontracted to small companies. Customarily there are not enough tools or manpower within the purchasing department of an agency to evaluate the impact that bundling has upon their local economies. The impact of bundling on a local economy cannot be measured by cost-savings alone. The costs and benefits of bundling on a local economy must also consider jobs lost and “multiplier” dollars lost. Accordingly, there is a need for a system where purchasing departments and buyers can quickly measure the economic impact of a bundled contract. There is also a need for a system that can maintain accurate information and can instantly link to various vendors to determine their ability to supply.

### BRIEF SUMMARY OF THE PRESENT INVENTION

The present invention comprises a new method and system for determining and reporting the impact of a purchasing decision on a community. The method involves collecting economic data for a state or county such as gross economic output, value added, labor income, indirect business taxes, and employment. Once the data is collected, the data is assigned to fields and permissions are assigned. The user can use the system to generate impact reports for the state or county by selecting the state or county of interest, and the appropriate industry category and project dollar amount. Such impact results can show the impact of purchasing decision on the community in terms of employment, indirect business taxes, value added, labor income, and capital income.

If upon reviewing the impact report a purchaser determines that cooperative purchasing is not advantageous to the community, it is often desirable to identify local suppliers who are capable of fulfilling the purchaser's, purchasing needs. The preferred embodiment includes a feature which allows the potential purchaser to test local supplier willingness, determine product availability for each purchase, and engage suppliers immediately. The system provides such information by collecting vendor data such as the vendor's state and county, industry categories, and email for receiving bid solicitations. This data is then assigned to fields. The purchaser selects the industry category and state(s) and/or counties of interest. The system generates a list of suppliers that meet the purchaser's description, and the user selects suppliers to which bid solicitations will be sent. The user inputs a description of the job, attaches the purchaser's standard contract, and the system sends emails solicitations for bids to the chosen suppliers.

### DESCRIPTION OF THE SEVERAL VIEWS OF THE DRAWINGS

FIG. 1 is a block diagram illustrating a configuration of a system for determining and reporting economic impact.

FIG. 2 is an example of the multiplier data stored in an economic database.

FIG. 3 is an illustration of an economic impact calculator graphical interface.

FIG. 4 is a flowchart illustration of report engine algorithms.

FIG. 5 is an illustration of a supplier locator graphical interface.

### REFERENCE NUMERALS IN THE DRAWINGS

| | | | |
|---|---|---|---|
| 10 | system start | 12 | main menu display |
| 14 | main menu routine entry point | 16 | block 16 |
| 18 | block 18 | 20 | calculator interface |
| 22 | block 22 | 24 | lookup function |
| 26 | impact report output | 28 | economic database |
| 30 | supplier locator interface | 32 | block 32 |
| 34 | lookup function | 36 | supplier database |
| 38 | block 38 | 40 | block 40 |
| 42 | lookup function | 44 | contract database |
| 46 | email output | 48 | drop-down box |
| 50 | list box | 52 | drop-down box |
| 54 | drop-down box | 56 | input field |
| 58 | add command button | 60 | check box |
| 62 | input field | 64 | list box |
| 66 | available reports | 68 | calculate command button |
| 70 | economic output report engine | 72 | county product report |
| | | | engine |
| 74 | labor income report engine | 76 | indirect business tax report |
| | | | engine |
| 78 | capital income report engine | 80 | employment report engine |
| 82 | drop-down box | 84 | list box |
| 86 | drop-down box | 88 | drop-down box |
| 90 | search command button | 92 | check box |
| 94 | input field | 96 | list box |
| 98 | text box | 100 | attachments |
| 102 | process command button | | |

### DESCRIPTION OF THE INVENTION

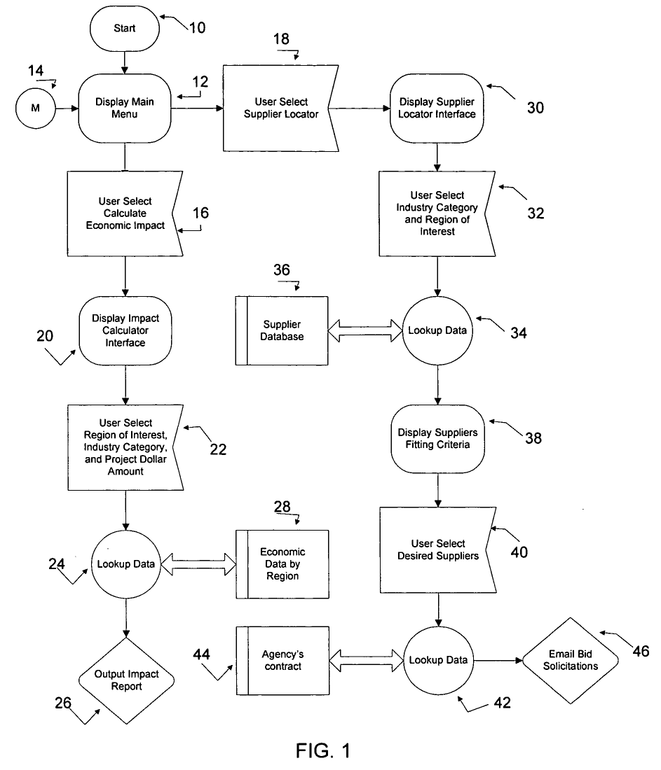

A configuration for a system for determining and reporting economic impact is shown in FIG. 1. The flowchart depicts main menu routines for software to be used in a data processing system according to the preferred embodiment of the present invention. System start 10 initiates the program and recalls main menu display 12 for the user. Main menu routine entry point 14 is provided to allow other routines to return to the main menu routine. From main menu display 12, the user cam either select to calculate the economic impact that a purchasing decision will have on a community via block 16 or select to locate potential suppliers via block 18. The reader will appreciate that a “main menu” is not a necessary element of the program; a “main menu” provides a simple entry point into the program where the user can either select to calculate the economic impact on a community or select to locate a supplier.

If the user selects to calculate economic impact, the program will recall calculator interface 20. From calculator interface 20, the user can select the region of interest, industry category, and project dollar amount for which the economic impact is to be determined via block 22. Based on the user's selections from block 22, the program performs lookup function 24 by retrieving the appropriate economic data for the region from economic database 28. The program performs any remaining necessary calculations and generates impact report output 26. The determination of economic impact and the impact report will be described subsequently.

If the user selects to locate potential suppliers, the program will recall supplier locator interface 30. From supplier locator interface 30, the user can select the industry category for the project and the region of interest via block 32. Based on the user's selections from block 32, the program performs lookup function 34 by retrieving all suppliers that meet the user's selected profile from supplier database 36. The program then displays a list of suppliers fitting the user's criteria in block 38. In block 40, the user selects suppliers to which bid solicitations will be sent from the list of suppliers in block 38. In the preferred embodiment the program also stores the user's standard contracts (such as offers for bids, purchase orders, etc.) in contract database 44. When the user selects the desired suppliers in block 40, they also can select which contract to attach to the bid solicitations. The program performs lookup function 42 to retrieve the contract and attaches it to bid solicitations which are emailed to the selected suppliers via email output 46.

To better understand how the economic impact on a community is determined, the routine corresponding to blocks 20, 22, 24, 26, and 28 will now be considered in detail. First, it is desirable to construct a database of economic data, corresponding to block 28 in FIG. 1, for a region. The purpose of the database is to store economic data that can be used in calculating the economic impact of a purchasing decision on a region.

The preferred database configuration stores “multiplier” totals for each industry in each region. “Multipliers” describe the response of the economy to a stimulus, a change in demand or production. These values are based on local economic interaction in terms of the flow of dollars from purchaser to producers within the region. Those that are skilled in the art know that “multipliers” can be determined using input-output analysis and economic modeling. The goal of economic modeling is to describe economic linkages and multiplying effects such as direct impact, indirect impact, and induced impact. “Direct impact” describes the increase in output of a commodity that results from an increase in demand of that commodity. As producers of the commodity increase their output of the commodity there is a corresponding increase on their suppliers and so on down the supplier chain; this is the “indirect impact.” “Induced impact” describes the phenomenon of increased spending on goods and services based on the increased income throughout the economy.

Input-output models can be used to derive sets of disaggregated multipliers based on the recognition that the total impact on output will vary according to the sector which experiences the initial increase in demand. In addition, the concept of a “multiplier” implicitly recognizes that the various sectors that make up the economy are interdependent. Accordingly, in addition to purchasing primary inputs, such as labor and imports, each sector will also purchase intermediate goods and services produced by companies within the local economy. The matrix of interdependence coefficients (often referred to as Leontief inverse matrix), which shows how much of each industry's output is required, in terms of direct and indirect requirements, to produce one unit of a given industry output is the primary input for constructing the multipliers. The Leontief inverse matrix is defined as:
Leontief Inverse Matrix=(I−A)⁻¹
Where A is the technical coefficient matrix (the ratio of the contribution of industry j to industry i divided by the gross output of industry i), and I is the identity matrix.

Multiplier data is available through Minnesota IMPLAN Group, Inc.'s (Stillwater, Minn.) database and is available for each state and county and each industry category. “Multiplier totals” can be generated by combining statistical data for households making less than $5,000 per year, households making between $5,000 and $10,000 per year, households making between $10,000 and $15,000 per year, households making between $15,000 and $20,000 per year, households making between $20,000 and $30,000 per year, households making between $30,000 and $40,000 per year, households making between $40,000 and $50,000 per year, households making between $50,000 and $70,000 per year, households making more than $70,000 per year, and capital. Accordingly, economic database 28 contains the totals for the above listed household income ranges and capital for the desired region(s) and industry categories.

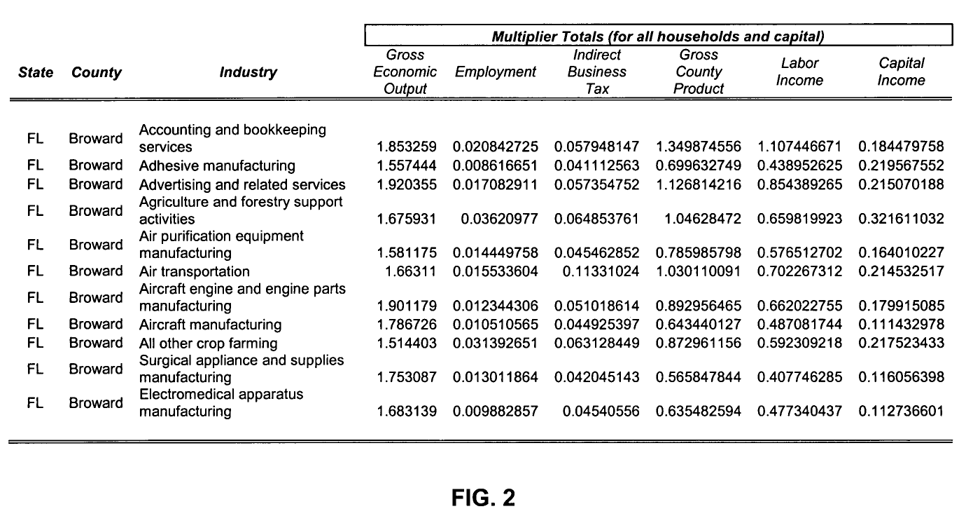

A sample of the contents of the economic database is shown in FIG. 2. The table shows the multiplier totals that correspond to three industry categories in Broward County, Fla. The reader will appreciate that there are different multiplier values for each “economic report” (Gross Economic Output, Gross County Product, Total Labor Income, Total Employment, Capital Income, and Indirect Business Taxes) and each “industry category” (Accounting and bookkeeping services, Adhesive manufacturing, Advertising and related services, etc.). It should be understood that a database can be constructed containing multiplier totals for all industry categories in all counties and states.

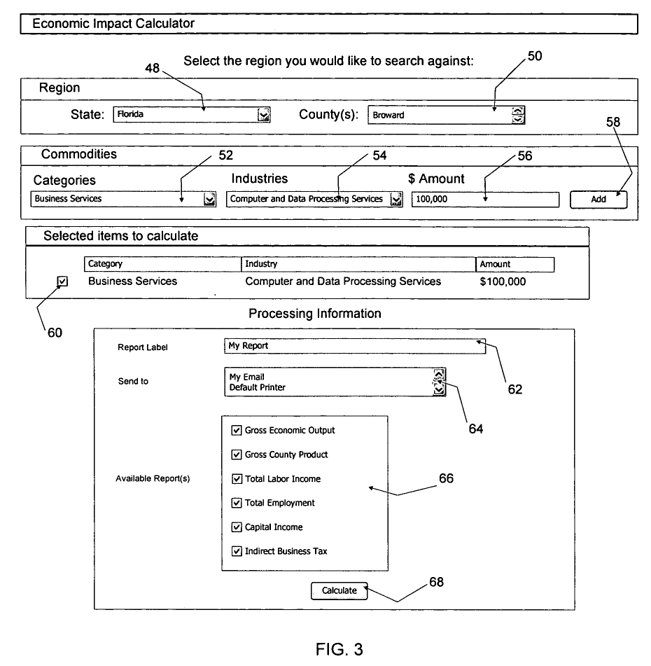

A graphical interface for determining economic impact, corresponding to block 20 in FIG. 1, is illustrated in FIG. 3. In the preferred embodiment, the user first selects a region of interest. The user initially selects a state from drop-down box 48. The user can then select the county(s) of interest from list box 50. In FIG. 3, the selected region of interest is Broward County, Fla. Once the user has selected the region of interest, the user selects the industry categories of interest. First, the user selects from a list of broad industry categories in drop-down box 52. In the preferred embodiment, the list of broad industry categories will include all categories applicable to the selected region. Once the user selects the broad industry categories, the user can then select the specific industry from drop-down box 54. Drop-down box 54 will show all industries that fall under the broad industry category that are known for the selected region. The user then inputs the estimated project value under input field 56 and selects add command button 58. The selected industry and project dollar amount is then temporarily stored so that the user can add other projects for which the determination of economic impact is desired. The search items that the user selects are listed and the user can cancel items from the search by deselecting check box 60. In FIG. 3, the user has selected to calculate impact that providing a $100,000 contract for computer and data processing to a Broward County company would have on Broward County.

Once the user has added all of the desired search items, the user then selects how they would like the report to be presented. The user inputs a title for the report in input field 62, and selects where the report is to be sent in list box 64. The user then selects which available reports 66 are desired, and selects calculate command button 68. The user can view the economic impact of a purchasing decision in terms of Gross Economic Output, Gross County Product, Total Labor Income, Total Employment, Capital Income, and Indirect Business Tax. The significance of these reports is explained in a subsequent example.

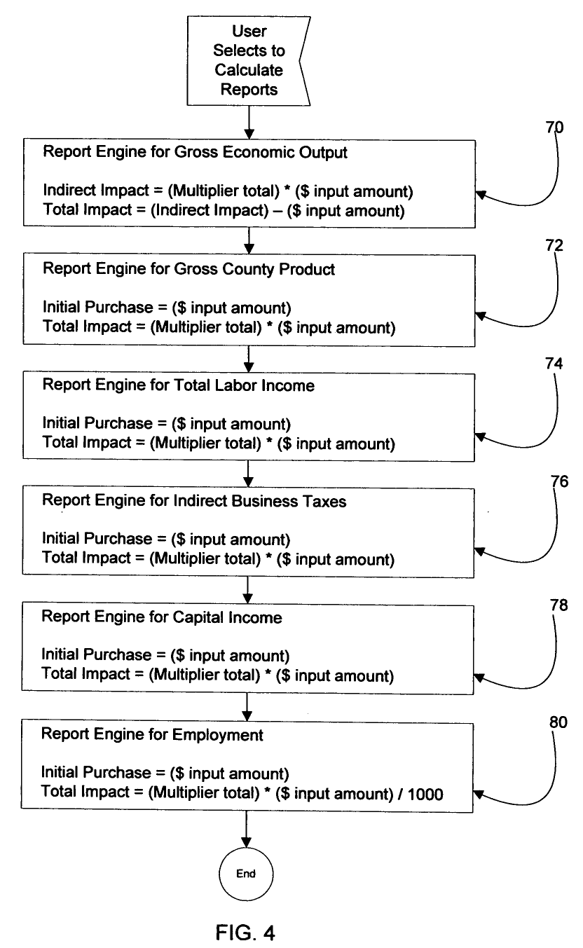

A flowchart illustration of report engines algorithms for reporting economic impact, corresponding to blocks 24, 26, and 28 in FIG. 1, is provided in FIG. 4. This illustration assumes that the user has selected to have the economic impact presented in terms of Gross Economic Output, Gross County Product, Total Labor Income, Total Employment, Capital Income, and Indirect Business Tax. The report engines use the project dollar amount input by the user and looks up the multiplier totals from economic database 28 that correspond to the region and industry categories selected by the user. A different multiplier total is used for each report engine as shown in FIG. 2.

As illustrated in FIG. 4, economic output report engine 70 calculates “indirect impact” by looking up the multiplier total corresponding to the region and industry category selected by the user from the economic database and multiplies the multiplier total with the project dollar amount input by the user. “Total impact” is determined by subtracting the project dollar amount input by the user from the calculated value for indirect impact. County product report engine 72 reports the total impact in terms of gross county product by multiplying the corresponding multiplier total with the project dollar amount input by the user. Labor income report engine 74 determines the total economic impact in terms of total labor income by multiplying the corresponding multiplier total with the project dollar amount input by the user. Indirect business tax report engine 76 determines the total economic impact in terms of indirect business taxes by multiplying the corresponding multiplier total with the project dollar amount input by the user. Capital income report engine 78 reports the total economic impact in terms of capital income by multiplying the corresponding multiplier total with the project dollar amount input by the user. Employment report engine 80 reports the total economic impact in terms of total employment by multiplying the corresponding multiplier total with the project dollar amount input by the user and dividing that value by 1000.

The reports can either be displayed on the screen, emailed to an electronic mail account, sent to a printer, saved to disk or any combination that the user desires.

### EXAMPLE

The invention may be better understood by the following example. In this example, a public hospital plans to purchase $30,000,000 worth of technical equipment that can be purchased from local manufacturers. The equipment to be purchased falls into three, more specific types of equipment, and the expenditures are apportioned in the following manner:

| | |
|---|---|
| Surgical and Medical Instruments | $15,000,000 |
| X-Ray Apparatus | $10,000,000 |
| Electromedical Apparatus | $5,000,000 |

The local economic impacts from purchasing locally are shown in the following tables.

Broward County Economic Impact
Report Date: Dec. 15, 2003
Gross Economic Output

| | | Indirect | |
|---|---|---|---|
| Impact | | and | |
| from Purchases Direct to | Direct | Induced | Total |
| the Following Local Industry: | Impact | Impact | Impact |
| Surgical Appliances and | $15,000,000 | $11,767,245 | $26,767,245 |
| Supplies | | | |
| X-Ray Apparatus | $10,000,000 | $6,619,300 | $16,619,300 |
| Electromedical Apparatus | $5,000,000 | $3,415,695 | $8,415,695 |
| TOTAL | $30,000,000 | $21,802,240 | $51,802,240 |

Gross Economic Output is the aggregated market value of goods and services produced by firms and government enterprises in the County's economy, and is essentially equal to the revenue collected by businesses (including indirect taxes) within the County. The table above shows that the total economic impact from the local purchase of the $30,000,000 of medical equipment is $51,802,240. This is the direct, indirect and induced economic impact. The purchase of Surgical and Medical Instruments has a total economic impact of $26,767,245 in the County, while the purchase of X-ray Equipment has an impact of $16,619,300. The total impact from the purchase of Electromedical apparatus is $8,415,695.

Broward County Economic Impact
Report Date: Dec. 15, 2003
Gross County Product (Total Value Added)

| Impact from Purchases Direct to | Total |
|---|---|
| the Following Local Industry: | Impact |
| Surgical Appliances and Supplies | $12,957,020 |
| X-Ray Apparatus | $4,922,135 |
| Electromedical Apparatus | $3,177,413 |
| TOTAL | $21,056,568 |

Gross County Product is the total value added created by the production of goods and services in the local economy. It is analogous to the concept of Gross Domestic Product at the national level, and it represents the sum of labor compensation, capital type income (profits, interests, and rents), and indirect business taxes (which are mainly sales taxes, but also include property taxes and government mandated fees). The table above indicates that the local purchase of $30,000,000 of medical equipment as specified in the table generates a total of $21,056,568 in Gross County Product. Gross County Product is always smaller than Gross Economic Output, and Gross Economic Output is the sum of Gross County Product and the purchase of intermediate inputs. Intermediate inputs include the purchase of goods and services by firms necessary to produce their output.

Broward County Economic Impact
Report Date: Dec. 15, 2003
Total Labor Income (Compensation)

| Impact from Purchases Direct to | Total |
|---|---|
| the Following Local Industry: | Impact |
| Surgical Appliances and Supplies | $9,734,787 |
| X-Ray Apparatus | $3,520,307 |
| Electromedical Apparatus | $2,386,702 |
| TOTAL | $15,641,796 |

Labor Income is the compensation to employees and self-employed proprietors including both wages and indirect payments such as retirement benefits, health insurance, and other similar fringe benefits. The table provides the direct, indirect and induced economic impacts from the purchase of each type of equipment.

Broward County Economic Impact
Report Date: Dec. 15, 2003
Total Employment (Jobs)

| Impact from Purchases Direct to | Total |
|---|---|
| the Following Local Industry: | Impact |
| Surgical Appliances and Supplies | 179.0 |
| X-Ray Apparatus | 94.2 |
| Electromedical Apparatus | 49.4 |
| TOTAL | 322.6 |

Employment is the number of jobs generated within the County, and includes both full-time and part-time positions (including both salary workers and sole proprietors). The table above indicates that a total of approximately 323 jobs are created from the purchase of the equipment specified in the tables. As in the other tables, the direct, indirect and induced jobs are shown in each row.

Broward County Economic Impact
Report Date: Dec. 15, 2003
Average Employee Compensation

| | Average |
|---|---|
| | Annual |
| Impact from Purchases Direct to | Compensation |
| the Following Local Industry: | Per Employee |
| Surgical Appliances and Supplies | $54,384 |
| X-Ray Apparatus | $37,371 |
| Electromedical Apparatus | $48,314 |
| All Jobs | $48,487 |

The table above provides the implicit average wage for the total employment impact shown in the previous table. The average annual compensation figures are computed by dividing the impact on labor incomes by the impact on jobs. These are not the average compensation for employees working in the industry shown along each row. The table indicates, for example, that the total jobs created from the purchase of Surgical Appliances and supplies have an average compensation of $54,384. All of the jobs generated by the purchases in this example are relatively “good jobs” in that the average annual compensation exceeds the State average of approximately $35,000.

Broward County Economic Impact
Report Date: Dec. 15, 2003
Capital Income (Profits, Interest Earnings, Rents)

| Impact from Purchases Direct to | Total |
|---|---|
| the Following Local Industry: | Impact |
| Surgical Appliances and Supplies | $2,332,514 |
| X-Ray Apparatus | $999,389 |
| Electromedical Apparatus | $563,683 |
| TOTAL | $3,895,586 |

Capital Income is the sum of all property type income (such as business profits, interest income and rental income) generated within the County. The impact from the purchase of each type of equipment is shown in this table, along with the combined impact of $3,895,586.

Broward County Economic Impact
Report Date: Dec. 15, 2003
Indirect Business Taxes (Taxes Excluding Income Taxes)

| Impact from Purchases Direct to | Total |
|---|---|
| the Following Local Industry: | Impact |
| Surgical Appliances and Supplies | $889,718 |
| X-Ray Apparatus | $402,440 |
| Electromedical Apparatus | $227,028 |
| TOTAL | $1,519,186 |

Indirect Business Taxes are taxes and fees that are not based on the businesses' income. For the most part they represent sales tax levied by the State and the county, but also include property taxes levied against businesses as well as fees imposed by federal, state and local governments.

In some cases, the user may determine that the economic impact of awarding a contract to a non-regional supplier of goods or services outweighs the amount of savings in total project cost that the non-regional supplier could provide. In this situation, it is desirable for the user to easily locate and send out bid solicitations to the appropriate regional suppliers. The routine corresponding to blocks 30, 32, 34, 36, 38, 40, 42, 44, and 46 address this need. As described in the description above, the user can select to locate a supplier, view suppliers meeting the user's criteria, and can send solicitations for bids to selected suppliers by email or other means.

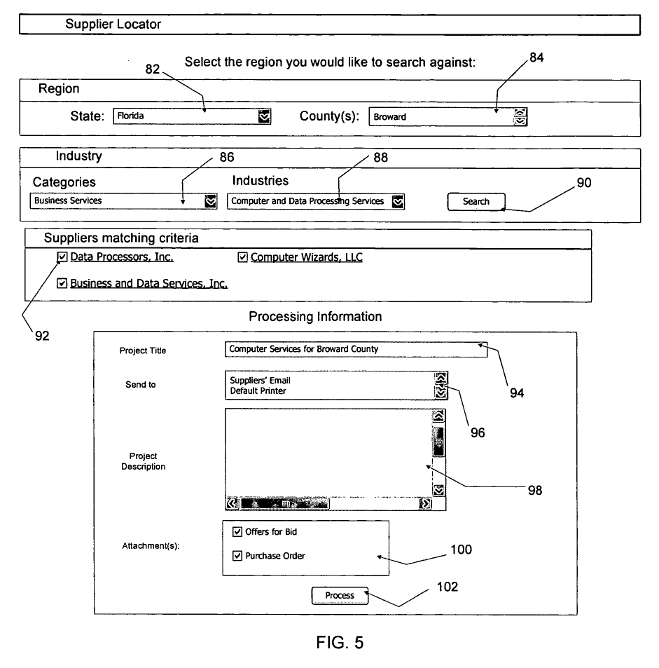

A supplier locator interface, corresponding to block 30 in FIG. 1, is illustrated in FIG. 5. Like the interface for the economic impact calculator, the user first selects the region of interest by selecting the appropriate state from drop-down box 82 and county(s) from list box 84. The desired broad category of industry is selected from drop-down box 86, and the specific industry is selected from drop-down box 88. As with the economic impact calculator interface, once the user has selected the region of interest, only the categories of industries available for that region are listed in drop-down box 86 and drop-down box 88. The user then selects search command button 90 to initiate the search. The suppliers meeting the user's search criteria are then displayed with check box 92. A link can be provided to each of the listed suppliers, so that the user can obtain more information on a given supplier if desired. The user selects or deselects suppliers as appropriate so that check box 92 is “checked” for all suppliers for which sending a bid solicitation is desired. The user then inputs a project title into input field 94, selects how the bid solicitation is to be sent from list box 96. As illustrated in FIG. 5, the user can select to print out the bid solicitation to be mailed or can email the solicitation directly to the supplier. The user then inputs the description of the project into text box 98, and selects which attachments 100, if any, to be included with the solicitation. Examples of possible attachments include contracts commonly used by the user such as offers for bid and purchase orders. Finally, the user selects process command button 102 to generate the correspondence. In the example shown in FIG. 5, the correspondence would be emailed directly to the supplier or printed out for mailing depending on the user's selection.

Although the preceding descriptions contain significant detail they should not be viewed as limiting the invention but rather as providing examples of the preferred embodiments of the invention. As one example, economic data for determining economic impact can be stored in many forms besides “multiplier” data. Changing the form of the data, however, does not depart from the spirit and scope of the invention. Accordingly, the scope of the invention should be determined by the following claims, rather than the examples given.

1. A method for allowing a user to determine the economic impact of a purchasing decision on a community comprising:
a. providing economic data for a geographic region;
b. establishing a plurality of categories for purposes of grouping said economic data;
c. grouping said economic data into said plurality of categories;
d. providing a graphical user interface, which allows said user to select a geographic region of interest, an industry category, and a project dollar amount; and
e. generating a report showing the economic impact of said purchasing decision on said geographic region of interest.

2. The method of claim 1, wherein said economic data comprises data for determining gross economic output for said geographic region.

3. The method of claim 1, wherein said economic data comprises data for determining gross county product for said geographic region.

4. The method of claim 1, wherein said economic data comprises data for determining labor income for said geographic region.

5. The method of claim 1, wherein said economic data comprises data for determining capital income for said geographic region.

6. The method of claim 1, wherein said economic data comprises data for determining indirect business tax for said geographic region.

7. The method of claim 1, wherein said economic data comprises data for determining total employment for said geographic region.

8. The method of claim 1, wherein said economic data comprises data for determining gross economic output, data for determining gross county product, and data for determining employment.

9. The method of claim 1, wherein said report showing said economic impact of said purchasing decision includes the impact on gross economic output for said geographic region of interest.

10. The method of claim 1, wherein said report showing said economic impact of said purchasing decision includes the impact on gross county product for said geographic region of interest.

11. The method of claim 1, wherein said report showing said economic impact of said purchasing decision includes the impact on labor income for said geographic region of interest.

12. The method of claim 1, wherein said report showing said economic impact of said purchasing decision includes the impact on capital income for said geographic region of interest.

13. The method of claim 1, wherein said report showing said economic impact of said purchasing decision includes the impact on indirect business tax for said geographic region of interest.

14. The method of claim 1, wherein said report showing said economic impact of said purchasing decision includes the impact on total employment for said geographic region of interest.

15. The method of claim 1, wherein said report showing said economic impact of said purchasing decision includes the impact on total employment for said geographic region of interest.

16. The method of claim 1, wherein said report showing said economic impact of said purchasing decision includes the impact on gross economic output, gross county product, and total employment for said geographic region of interest.

17. The method of claim 1, comprising the additional steps of:
a. providing data regarding a plurality of suppliers, including
i. said plurality of suppliers corresponding geographic locations, and
ii. said plurality of suppliers corresponding industry classifications,
b. establishing a plurality of categories for purposes of grouping said data regarding said plurality of suppliers;
c. grouping said data regarding said plurality of suppliers into said plurality of categories;
d. providing a second graphical user interface, which allows said user to select a geographic region of interest and an industry category; and
e. generating a report showing the suppliers which correspond to said users selections of said geographic region of interest and said industry category.

18. A method for allowing a user to determine the economic impact of a purchasing decision on a community comprising:
a. providing economic data for a plurality of geographic regions, including,
i. data for determining gross economic output,
ii. data for determining gross county product, and
iii. data for determining total employment;
b. establishing a plurality of categories for purposes of grouping said economic data;
c. grouping said economic data into said plurality of categories;
d. providing a graphical user interface, which allows said user to select a geographic region of interest, an industry category, and a project dollar amount; and
e. generating a report showing the economic impact of said purchasing decision on said geographic region of interest, said report including,
i. the impact on gross economic output for said geographic region of interest,
ii. the impact on gross county product for said geographic region of interest, and
iii. the impact on total employment for said geographic region of interest.

19. The method of claim 18, wherein said economic data further comprises data for determining labor income, data for determining capital income, and data for determining indirect business tax for each of said plurality of regions.

20. The method of claim 19, wherein said report further includes the impact on labor income for said geographic region of interest, the impact on capital income for said geographic region of interest, and the impact on indirect business tax for said geographic region of interest.
